(19) United States
(12) Patent Application Publication
(10) Pub. No.: US 2014/0244449 A1
(43) Pub. Date: Aug. 28, 2014

(54) Integrated system for calculating savings at several stages of procurement cycle by auto-fetching spend data into savings tracker system

(71) Applicants: BIKASH MOHANTY, MUMBAI (IN); ASHISH MOHAN JHA, MUMBAI (IN); PRASAD NAIR, MUMBAI (IN)

(72) Inventors: BIKASH MOHANTY, MUMBAI (IN); ASHISH MOHAN JHA, MUMBAI (IN); PRASAD NAIR, MUMBAI (IN)

(21) Appl. No.: 13/939,005

(22) Filed: Jul. 10, 2013

(30) Foreign Application Priority Data
Feb. 27, 2013 (IN) 567/MUM/2013

(51) Int. Cl. G06Q 40/00

(52) U.S. Cl. CPC G06Q 40/10
USPC 705/30

(57) ABSTRACT

An integrated system is described for calculating savings at several stages of the procurement cycle by auto-fetching spend data into a savings tracker system. The system comprises: a processor unit; and a computer readable medium storing instructions executable by the processor unit comprising: an integrated spend data input system adapted for auto-fetching of spend data from the respective systems; a savings computing system adapted for computing savings at several stages of the procurement cycle by comparing the auto-fetched baseline spend and spend at each stage of the procurement cycle by general formula: (auto-fetched baseline spend)−(spend at the specific stage of the procurement cycle)=(savings at the respective stage of the procurement cycle); and a display system adapted for displaying the savings at the respective stages of the procurement cycle.

### CROSS-REFERENCE TO RELATED APPLICATION

The instant application claims priority to Indian Patent Application Serial No. 567/MUM/2013, filed Feb. 27, 2013, pending, the entire specification of which is expressly incorporated herein by reference.

### FIELD OF THE INVENTION

The present invention relates generally to electronic procurement, and more particularly, to calculating savings by auto-fetching spend data. The present invention discloses an integrated system and a method for calculating savings at several stages of the procurement cycle by auto-fetching spend data into a savings tracker system.

### BACKGROUND OF THE INVENTION

Once procurement professionals decide on which goods to buy, a sourcing project for the good is typically launched. The sourcing project may have multiple stages and savings and may be reported across each stage until the time of buying. These stages could be: potential stage; negotiated stage; contract stage; implemented stage; or realized stage. The challenge is how to estimate spend data (e.g., baseline spend) at each stage to calculate the savings by comparing baseline spend and actual spend. Generally, at each of these stages, savings are calculated by providing spend data manually.

Accordingly, there exists a need for new and improved systems and methods for electronic procurement of goods that overcome at least one of the aforementioned disadvantages.

### SUMMARY OF THE INVENTION

The present invention provides an advantage by introducing an integrated system and a method for calculating savings at several stages of the procurement cycle by auto-fetching spend data into a savings tracker system. This baseline spend data may be fetched automatically from different systems, e.g., a spend management system, a database of contracts of suppliers, an auction and bids information system, or an e-procurement system, all of which may be integrated with the savings tracker system at each different stage of the procurement cycle.

An object of the present invention is to provide integrated systems and methods for calculating savings at several stages of the procurement cycle by auto-fetching spend data into the savings tracker system.

Another object of the present invention is to provide systems and methods for auto-fetching of the baseline spend data from different systems, e.g., a spend management system, a database of contracts of suppliers, an auction and bids information system, or an e-procurement system, all of which may be integrated with the savings tracker system at each different stage of the procurement cycle.

In accordance with one embodiment of the present invention, a system is provided containing an integration of several systems for calculating savings at several stages of the procurement cycle by auto-fetching spend data into the savings tracker system, the system comprising:

a processor unit; and

a computer readable medium storing instructions executable by the processor unit comprising:

an integrated spend data input system adapted for auto-fetching of the baseline spend data from the respective system;

a savings computing system adapted for computing savings at several stages of the procurement cycle by comparing the auto-fetched baseline spend and spend at each stage of the procurement cycle by the general formula:

(auto-fetched baseline spend)−(spend at the specific stage of the procurement cycle)=(savings at the respective stage of the procurement cycle);

and

a display system adapted for displaying savings at the respective stages of the procurement cycle.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention will now be described in relation to the accompanying drawings in which:

FIG. 1 illustrates a schematic showing an integrated system for savings calculation containing an integration of different systems;

FIG. 2 illustrates a schematic showing the different stages of the procurement cycle at which savings are to be calculated;

FIG. 3 illustrates a schematic showing the flow of spend data in the savings tracker system from other integrated systems at each different stage of the procurement cycle; and

FIGS. 4-12 illustrate several screen captures of the steps involved in a system for calculating savings by auto-fetching spend data from other integrated systems.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

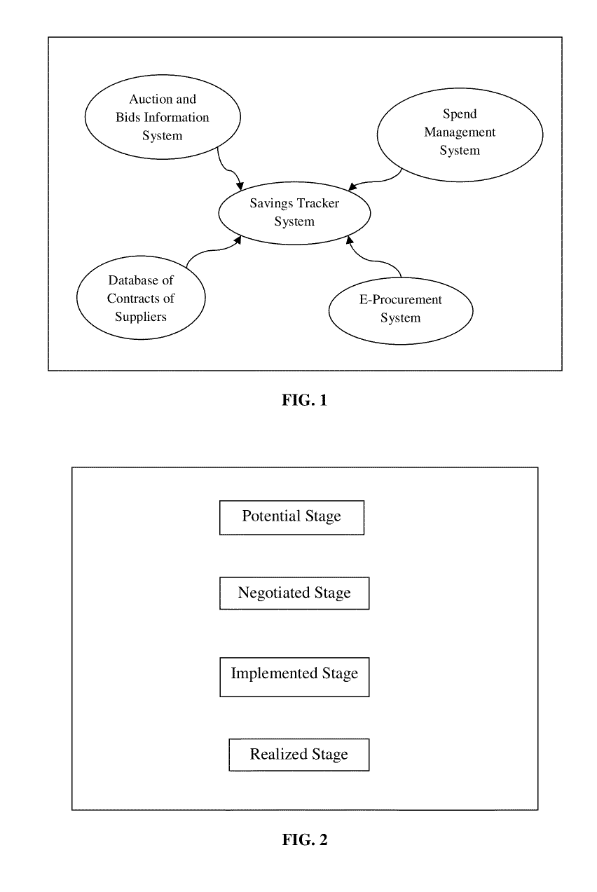

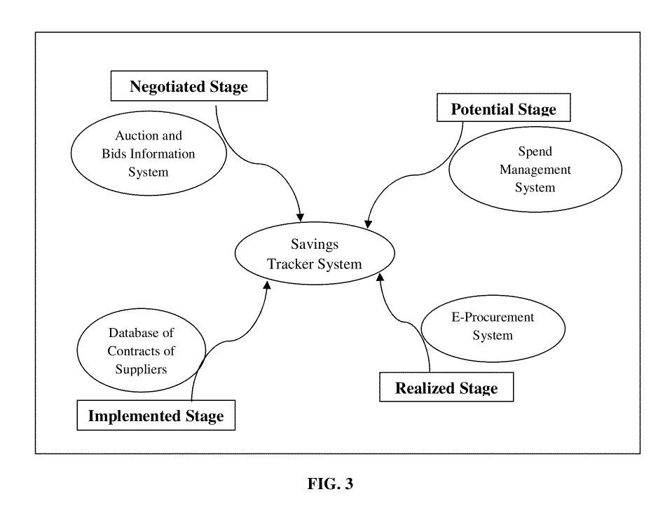

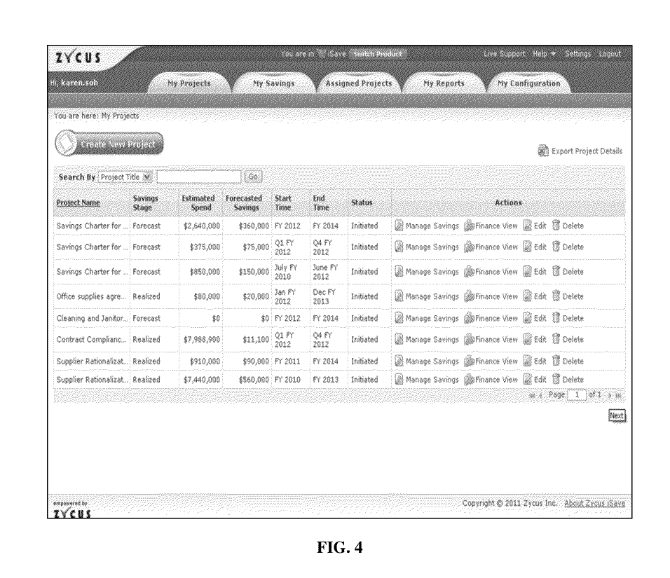

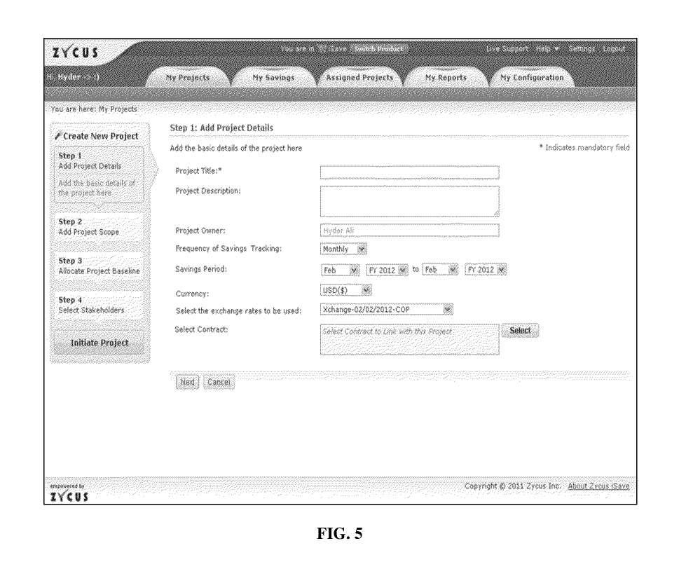

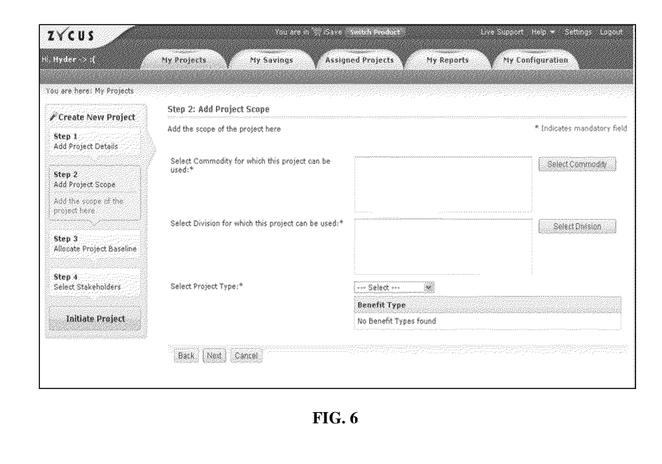

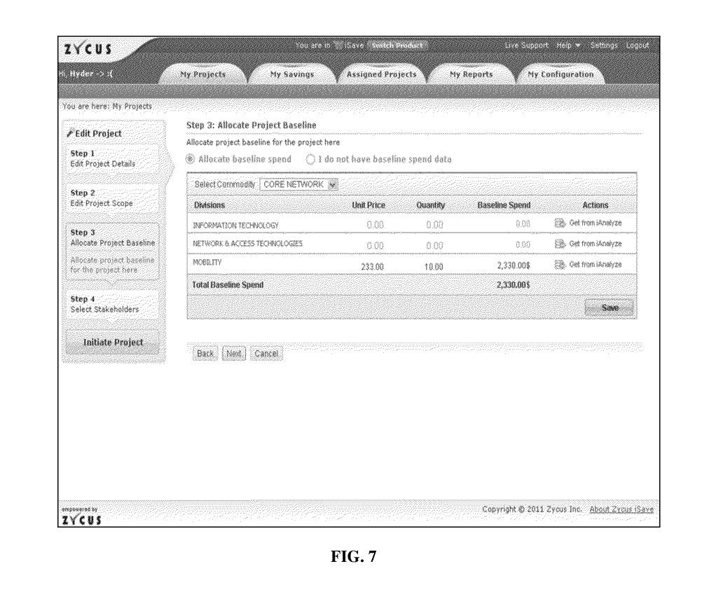

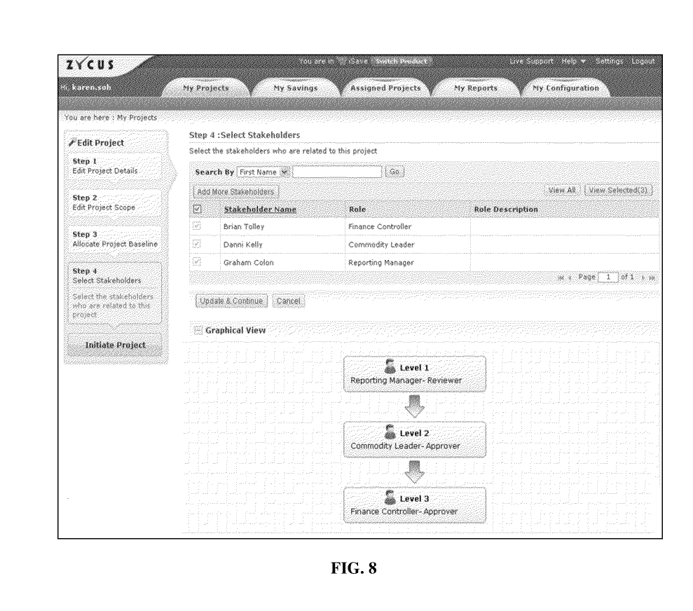

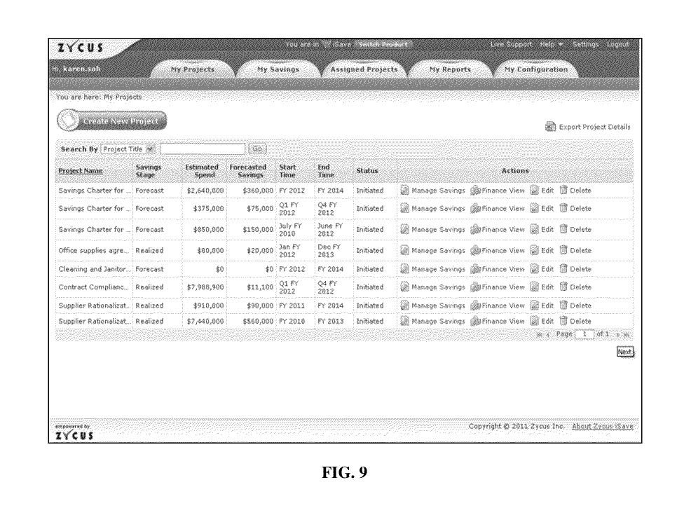

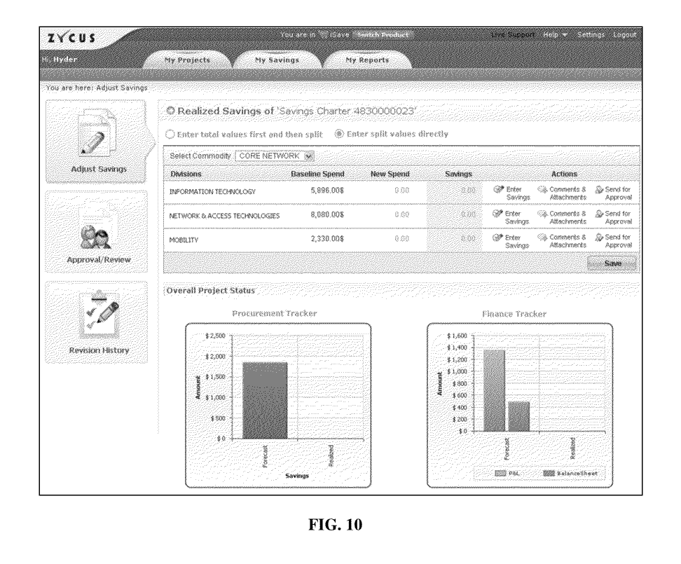

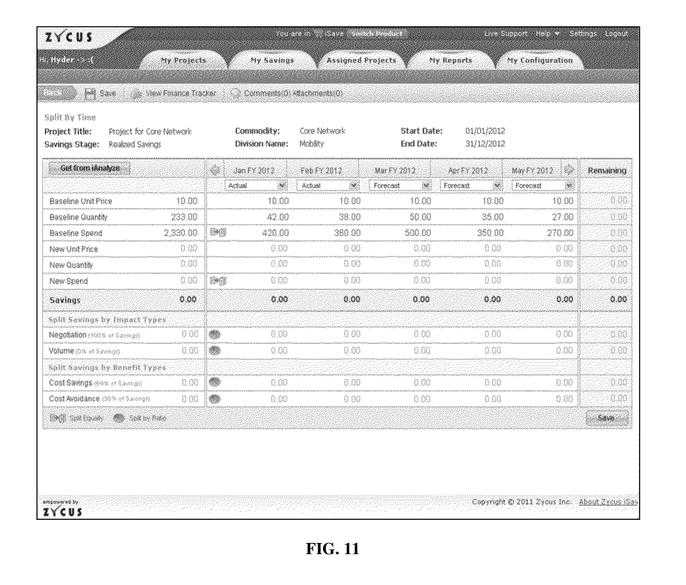

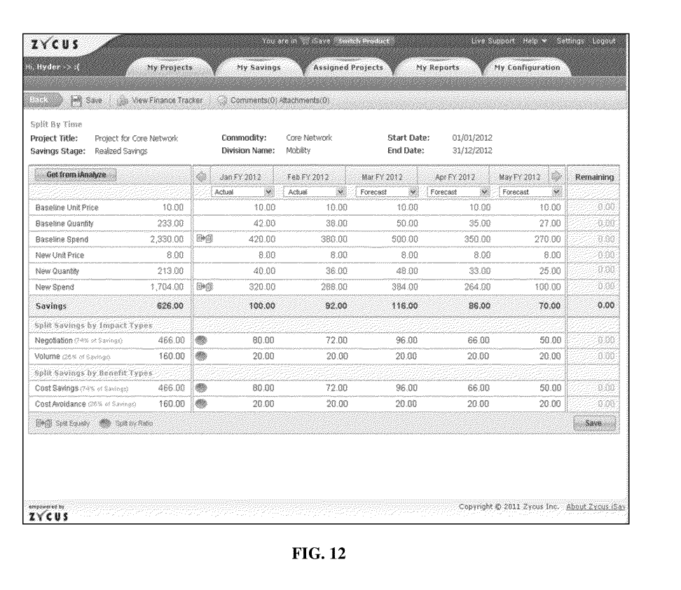

Referring to FIGS. 1-12, and according to an exemplary embodiment, a system is provided containing an integration of several systems for calculating savings at several stages of the procurement cycle by auto-fetching spend data into the savings tracker system, the system comprising:

a processor unit; and

a computer readable medium storing instructions executable by the processor unit comprising:

a spend data input system adapted for auto-fetching of spend data from the respective systems;

a savings computing system adapted for computing savings at several stages of the procurement cycle by comparing auto-fetched baseline spend and spend at each stage of the procurement cycle by general formula:

(auto-fetched baseline spend)−(spend at the specific stage of the procurement cycle)=(savings at the respective stage of the procurement cycle);

and

a display system adapted for displaying savings at the respective stages of the procurement cycle.

According to an exemplary embodiment, the system contains an integration of a spend management system, an auction and bids information system, a database of contracts of suppliers, or an e-procurement system, with the saving tracker system.

According to another exemplary embodiment, the several stages of the procurement cycle may include potential stage, negotiated stage, contract stage, implemented stage, or realized stage. The potential stage of the procurement cycle is an initial stage of the procurement cycle where spends are forecasted and the savings at the potential stage are potential/forecasted savings. The negotiated stage is the stage where price negotiations are done by the buyer and spends are re-forecasted as per new price negotiations, and the savings at the negotiated stage are negotiated savings. While the implemented stage is a stage where the price of purchasing of the goods is finalized, and the savings at the implemented stage are implemented savings and the realized stage is a stage where the actual price is paid to the vendor, and the savings at the realized stage are realized savings.

According to yet another exemplary embodiment, when the specific procurement stage entered or activated into the savings tracker system, the system recognizes the specific procurement stage and activates the respective integrated system to provide the requisite auto-populated baseline information based on the pre-configured decision rule(s). These pre-configured decision rule(s) being responsible for triggering the respective integrated system upon entering set of words into the Savings Tracker System to denote starting of specific procurement stage. For example, the savings tracker system when the word negotiated stage is typed or any such synonym is typed into, there are pre-configured decision rules to recognize such words and upon recognition they trigger the activation of respective integrated system to fetch the auto baseline data.

According to yet another exemplary embodiment, these stages of the procurement cycle are mapped to several different systems, e.g., the spend management system, an auction and bids information system, a database of contracts of suppliers, and an e-procurement system, all of which may be adapted for gathering information automatically from these systems when the project reaches a respective stage, which further aids to forecast the spend and calculate savings.

According to still another exemplary embodiment, the spend data at a potential stage may be obtained from the spend management system. The system enables the user to select the spend data of a specific year as a potential spend based on pre-configured decision rules. The spend data at the negotiated stage may be obtained from the auction and bids information system. The system enables the user to select the specific bidder's information as the negotiated spend based on pre-configured decision rules. The database of contracts of suppliers may provide the spend data at the implemented stage which is an agreed contracted price for the item and the e-procurement system may provide the spend data at the realized stage which is invoiced spend data for the item.

According to another exemplary embodiment, the savings at each of these stages, e.g., potential stage, negotiated stage, contract stage, implemented stage and realized stage, may be calculated respectively by the formulae:

(auto fetched baseline spend)−(potential/forecasted spend)=potential/forecasted savings;

(auto fetched baseline spend)−(negotiated spend)=negotiated savings;

(auto fetched baseline spend)−(implemented spend)=implemented savings;

or

(auto fetched baseline spend)−(realized spend)=realized savings.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An integrated system for calculating savings at several stages of a procurement cycle by auto-fetching spend data into a savings tracker system, comprising:
a processor unit; and
a computer readable medium storing instructions executable by the processor unit comprising:
an integrated spend data input system adapted for auto-fetching of baseline spend data from a respective integrated system at each stage of the procurement cycle;
a savings computing system adapted for computing savings at several stages of the procurement cycle by comparing auto-fetched baseline spend and spend information at each stage of the procurement cycle by general formula:
(auto-fetched baseline spend)−(spend at a specific stage of the procurement cycle)=(savings at the respective stage of the procurement cycle);
and
a display system adapted for displaying savings at the respective stages of the procurement cycle.

2. The system according to claim 1, wherein the system contains an integration of a spend management system, an auction and bids information system, a database of contracts of suppliers, or an e-procurement system with the savings tracker system.

3. The system according to claim 1, wherein, the several stages of the procurement cycle include potential stage, negotiated stage, contract stage, implemented stage or realized stage.

4. The system according to claim 1, wherein, when the specific procurement stage entered or activated into the savings tracker system, the system recognizes the specific procurement stage and activates the respective integrated system to provide the requisite auto-populated baseline information based on the pre-configured decision rule(s).

5. The system according to claim 4, wherein the pre-configured decision rule(s) being responsible for triggering the respective integrated system upon entering set of words into the savings tracker system to denote starting of specific procurement stage.

6. The system according to claim 3, wherein the baseline spend data at a potential stage is auto fetched/obtained from the spend management system integrated with the savings analysis system, wherein the potential/forecasted savings is calculated by the formula:
(auto-fetched baseline spend)−(potential/forecasted spend)=potential/forecasted savings.

7. The system according to claim 6, wherein a user presets for auto fetching of spend data of a specific year as a baseline spend at the potential stage based on a pre-configured decision rule.

8. The system according to claim 3, wherein the baseline spend data at the negotiated stage is auto fetched/obtained from the auction and bids information system, integrated with savings analysis system, wherein the negotiated savings is calculated by the formula:
(auto-fetched baseline spend)−(negotiated spend)=negotiated savings.

9. The system according to claim 8, wherein a user presets for auto fetching of a specific bidder's information as the baseline spend at the negotiated stage based on a pre-configured decision rule.

10. The system according to claim 3, wherein the baseline spend data at the implemented stage is auto fetched/obtained from the database of contracts of suppliers, integrated with savings analysis system, wherein the implemented savings at the implemented stage is calculated by the formula:
(auto-fetched baseline spend)−(implemented spend)=implemented savings.

11. The system according to claim 10, wherein a user presets the auto-fetching/auto-populating of a specific supplier's contract price information as the baseline spend at the implemented stage based on a pre-configured decision rule.

12. The system according to claim 3, wherein the e-procurement system provides the auto-fetched baseline spend data at the realized stage, wherein the realized savings is calculated by the formula:
(auto-fetched baseline spend)−(realized spend)=realized savings.

13. The system according to claim 12, wherein a user presets the auto-fetching of a specific supplier's invoice data as the baseline spend at the realized stage based on a pre-configured decision rule.

14. A method for calculating savings at several stages of a procurement cycle by auto-fetching spend data into a savings tracker system, comprising:
auto-fetching the spend data from a respective system of an integrated system;
computing savings at several stages of the procurement cycle by comparing auto-fetched baseline spend and spend at each stage of the procurement cycle by the general formula:
(auto-fetched baseline spend)−(spend at a specific stage of the procurement cycle)=(savings at the respective stage of the procurement cycle);
and
displaying savings at the respective stages of the procurement cycle.

15. The method according to claim 14, wherein the step of computing savings is calculated by an integration of a spend management system, an auction and bids information system, a database of contracts of suppliers or an e-procurement system, with the saving tracker system.

16. The method according to claim 14, wherein the step of computing savings at the several stages of the procurement cycle includes a potential stage, a negotiated stage, a contract stage, an implemented stage or a realized stage.

17. The method according to claim 16, wherein the step of computing potential/forecasted savings involves obtaining the auto-fetched baseline spend data at the potential stage from the spend management system, wherein the potential/forecasted savings is calculated by the formula:
(auto-fetched baseline spend)−(potential/forecasted spend)=potential/forecasted savings.

18. The method according to claim 17, wherein the user selects the spend data of a specific year as a potential spend based on a pre-configured decision rule.

19. The method according to claim 16, wherein the step of computing negotiated savings involves obtaining the auto-fetched baseline spend data at the negotiated stage from the auction and bids information system, wherein the negotiated savings is calculated by the formula:
(auto-fetched baseline spend)−(negotiated spend)=negotiated savings.

20. The method according to claim 19, wherein the user selects a specific bidder's information as a negotiated spend based on a pre-configured decision rule.

21. The method according to claim 16, wherein the step of computing the implemented savings involves obtaining the auto-fetched baseline spend data at the implemented stage from the database of contracts of suppliers, wherein the implemented savings is calculated by the formula:
(auto-fetched baseline spend)−(implemented spend)=implemented savings.

22. The method according to claim 16, wherein the step of computing the realized savings involves obtaining the auto-fetched baseline spend data at the realized stage from the e-procurement system, wherein the realized savings is calculated by the formula:
(auto-fetched baseline spend)−(realized spend)=realized savings.
